(19) United States
(12) Patent Application Publication
(10) Pub. No.: US 2014/0330906 A1
(43) Pub. Date: Nov. 6, 2014

(54) SYSTEMS AND METHODS OF NETWORK PROCESSING/CREATION INVOLVING ENGAGEMENT TOOLS, POLLING, MESSAGING, FEEDBACK AND/OR OTHER FEATURES

(71) Applicants: Mandeep DHILLON, San Jose, CA (US); Kabir S. MAHAL, San Jose, CA (US); Derek E. BAIRD, Coto de Caza, CA (US); Jeffrey J. BAYER, San Francisco, CA (US); Ravjeer Singh Tut, Mountain View, CA (US); Rishi Mallik, Chino Hills, CA (US); Akshat Bhat, San Jose, CA (US); Zuhayeer Musa, Cupertino, CA (US); Naoya Kanai, Palo Alto, CA (US); Collin Hartigan, Los Gatos, CA (US)

(72) Inventors: Mandeep DHILLON, San Jose, CA (US); Kabir S. MAHAL, San Jose, CA (US); Derek E. BAIRD, Coto de Caza, CA (US); Jeffrey J. BAYER, San Francisco, CA (US); Ravjeer Singh Tut, Mountain View, CA (US); Rishi Mallik, Chino Hills, CA (US); Akshat Bhat, San Jose, CA (US); Zuhayeer Musa, Cupertino, CA (US); Naoya Kanai, Palo Alto, CA (US); Collin Hartigan, Los Gatos, CA (US)

(21) Appl. No.: 14/270,334

(22) Filed: May 5, 2014

Related U.S. Application Data
(60) Provisional application No. 61/819,522, filed on May 3, 2013.

(51) Int. Cl. H04L 29/08

(52) U.S. Cl. CPC H04L 67/18
USPC 709/204

(57) ABSTRACT

Aspects of the present innovations relate to systems and methods of a data processing involving network processing, engagement tools, social polling, messaging, custom image creation and/or feedback, among other features. In one illustrative implementation, a network may provide custom engagement tools targeting a specific audience. Further, engagement tools directly focusing on the network and its feedback may be provided, for example, to provide aspects over other social networks where users are grouped into general categories without specific features.

### CROSS-REFERENCE TO RELATED APPLICATION INFORMATION

This application claims benefit of/priority to provisional patent application No. 61/819,522, filed May 3, 2013, which is incorporated herein by reference in entirety.

### FIELD

Innovations herein pertain to computer software and hardware, systems and methods of data processing involving network processing, academic information, verification, social polling, visualization, messaging, and/or custom image creation.

### APPENDICES

This application incorporates the attached Appendices of computer code and representative commands in connection with which aspects of the innovations herein may be utilized.

### OVERVIEW OF SOME ASPECTS

Systems, methods, computer readable media and articles of manufacture consistent with innovations herein are directed to network processing among students. A mobile device such as a smartphone including a GPS system may be provided to determine an academic network of a user based on a mobile device location from the GPS system. The user checks in to the academic network and the user is verified.

According to some illustrative implementations, innovations herein may provide the ability to process data by displaying a plurality of social network contacts, displaying a plurality of contexts of the social network contacts and switching display of social network contacts based on a selected context.

It is to be understood that both the foregoing general description and the following detailed description are exemplary and explanatory only and are not restrictive of the inventions, as described. Further features and/or variations may be provided in addition to those set forth herein. For example, the present inventions may be directed to various combinations and subcombinations of the disclosed features and/or combinations and subcombinations of several further features disclosed below in the detailed description.

### BRIEF DESCRIPTION OF THE DRAWINGS

The accompanying drawings, which constitute a part of this specification, illustrate various implementations and features of the present innovations and, together with the description, explain aspects of the inventions herein. In the drawings:

FIG. 1 is a display illustrating school selection consistent with certain aspects related to the innovations herein.

FIG. 2 is a display illustrating location determination consistent with certain aspects related to the innovations herein.

FIG. 3 is a display illustrating school selection consistent with certain aspects related to the innovations herein.

FIG. 4 is a display illustrating school selection consistent with certain aspects related to the innovations herein.

FIG. 5 is a display illustrating filtering consistent with certain aspects related to the innovations herein.

FIG. 6 is a display illustrating feed selection consistent with certain aspects related to the innovations herein.

FIG. 7 is a display illustrating contacts consistent with certain aspects related to the innovations herein.

FIG. 8 is a display illustrating a contact filtering consistent with certain aspects related to the innovations herein.

FIG. 9 is a display illustrating filtered contacts consistent with certain aspects related to the innovations herein.

FIG. 10 is a display illustrating a filtering process consistent with certain aspects related to the innovations herein.

FIG. 11 is a display illustrating a selection process consistent with certain aspects related to the innovations herein.

FIG. 12 is a display illustrating a setup process consistent with certain aspects related to the innovations herein.

FIG. 13 is a display illustrating polling consistent with certain aspects related to the innovations herein.

FIG. 14 is a display illustrating polling consistent with certain aspects related to the innovations herein.

FIG. 15 is a display illustrating contact selection consistent with certain aspects related to the innovations herein.

### DETAILED DESCRIPTION OF ILLUSTRATIVE IMPLEMENTATIONS

Reference will now be made in detail to the inventions herein, examples of which are illustrated in the accompanying drawings. The implementations set forth in the following description do not represent all implementations consistent with the inventions herein. Instead, they are merely some examples consistent with certain aspects related to the present innovations. Wherever possible, the same reference numbers are used throughout the drawings to refer to the same or like parts.

To solve one or more of the drawbacks mentioned above and/or other issues, implementations herein may provide a network providing custom engagement targeted towards a specific audience such as a high school. Unlike other social networks that group users into general categories without specific features, the invention creates a network where the engagement tools—social polling and messaging—directly focus on the network and its feedback.

As set forth in more detail below, aspects of the innovations herein relate to determining an academic network of a user based on a mobile device location from the GPS system, as well as for checking-in to the academic network and verifying the user.

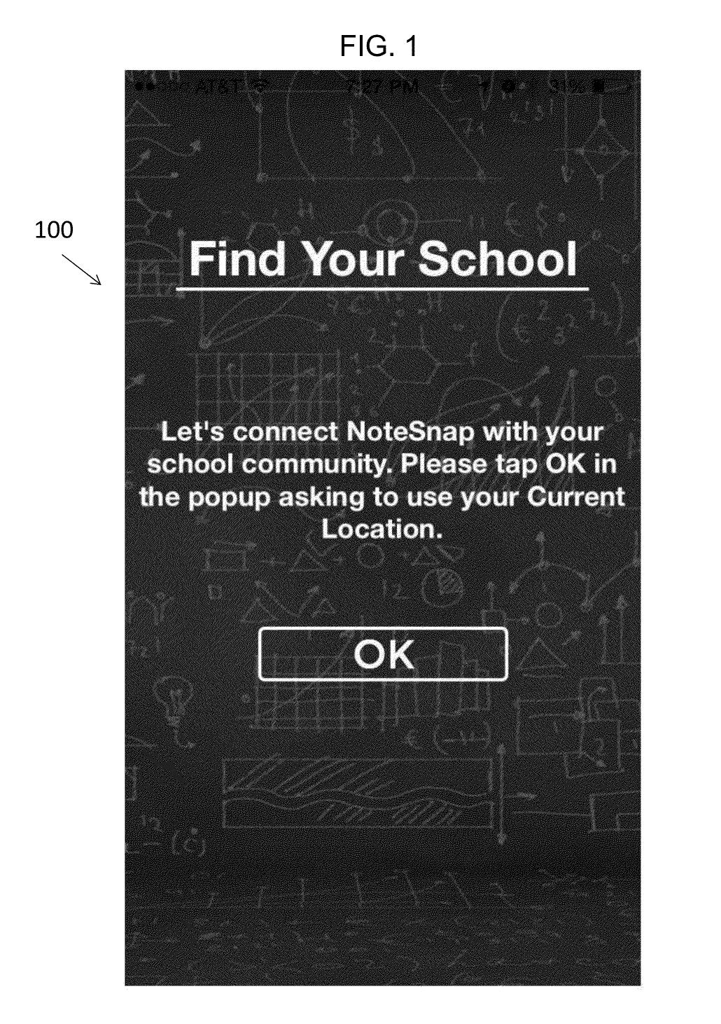

FIG. 1 is a display illustrating school selection consistent with certain aspects related to the innovations herein. Referring to FIG. 1, to begin, the user taps on the OK button, as illustrated in the display 100 of FIG. 1, and this allows the application to request location permission.

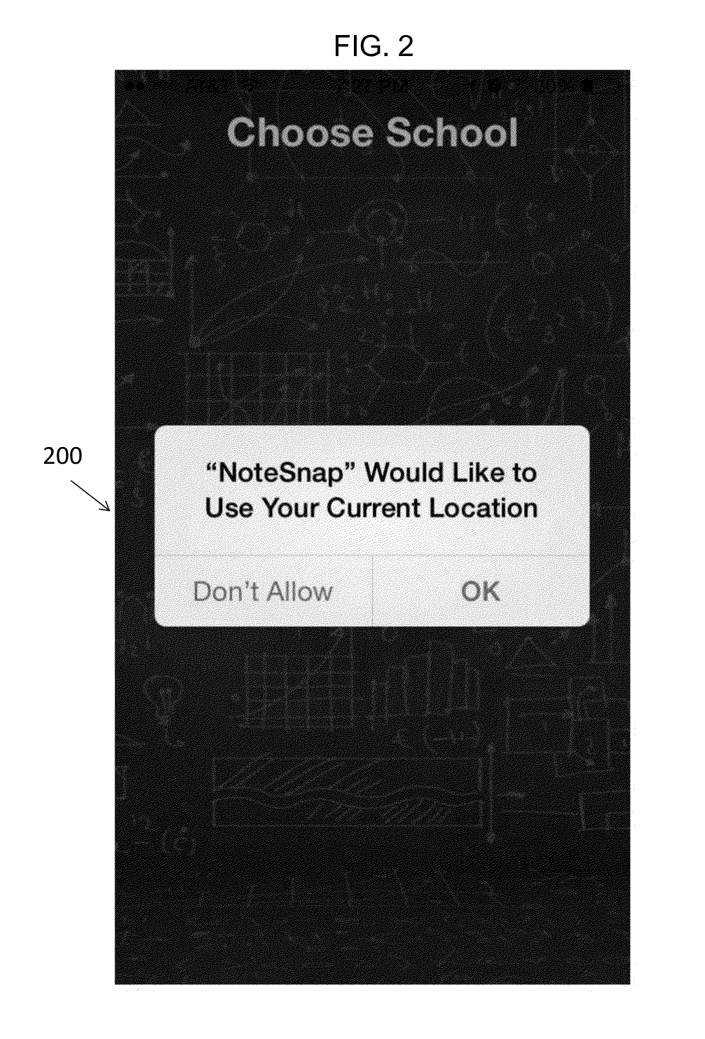

FIG. 2 is a display illustrating location determination consistent with certain aspects related to the innovations herein. Upon selection of OK in FIG. 1, the application proceeds to request location permission as illustrated in the display 200 of FIG. 2. The user agrees to give us permission to access their location.

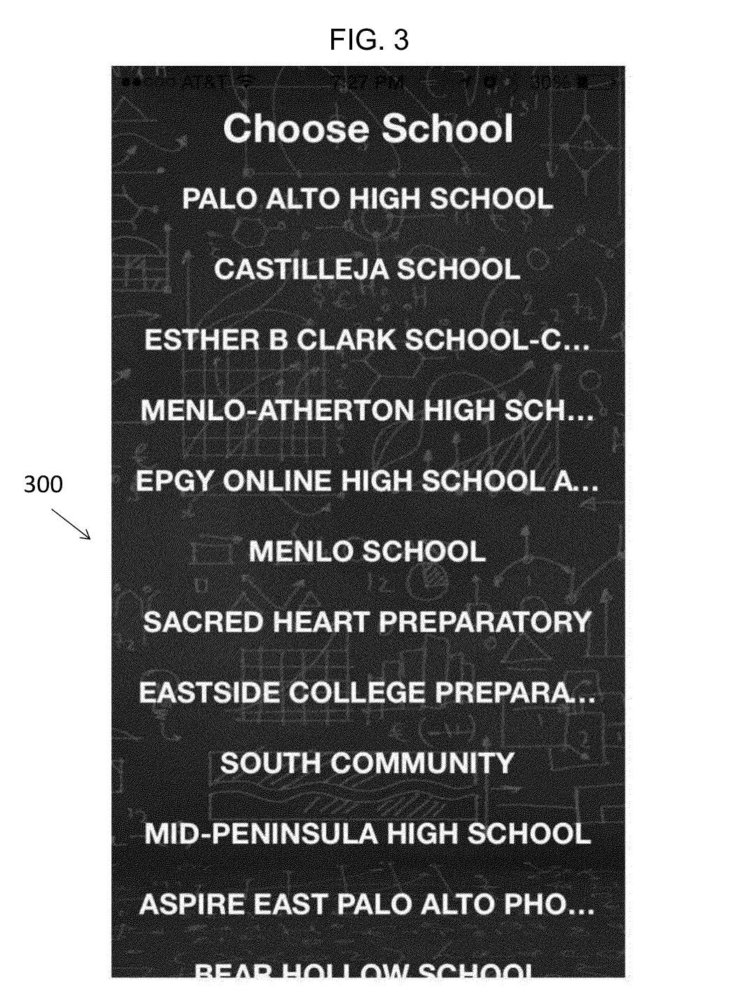

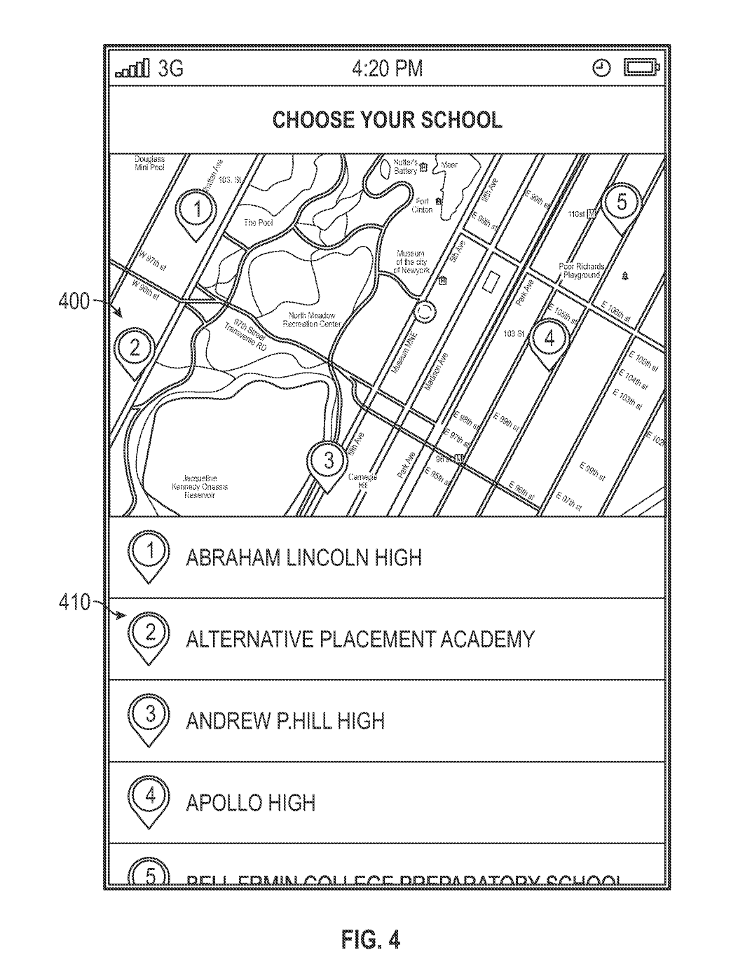

FIG. 3 is a display illustrating school selection consistent with certain aspects related to the innovations herein. FIG. 3 is a display 300 illustrating school selection with a plurality of schools within the specified radius. An alternative display 400 is provided in FIG. 4.

FIG. 4 is a display illustrating school selection consistent with certain aspects related to the innovations herein. In some implementations, a student based high school social network is provided that uniquely identifies and validates student information on two different levels. During a sign up process to the high school network, the GPS coordinates of a user device will be determined by the user mobile device. A list of high schools within a predetermined radius of the user coordinates will be displayed, as illustrated in FIG. 4.

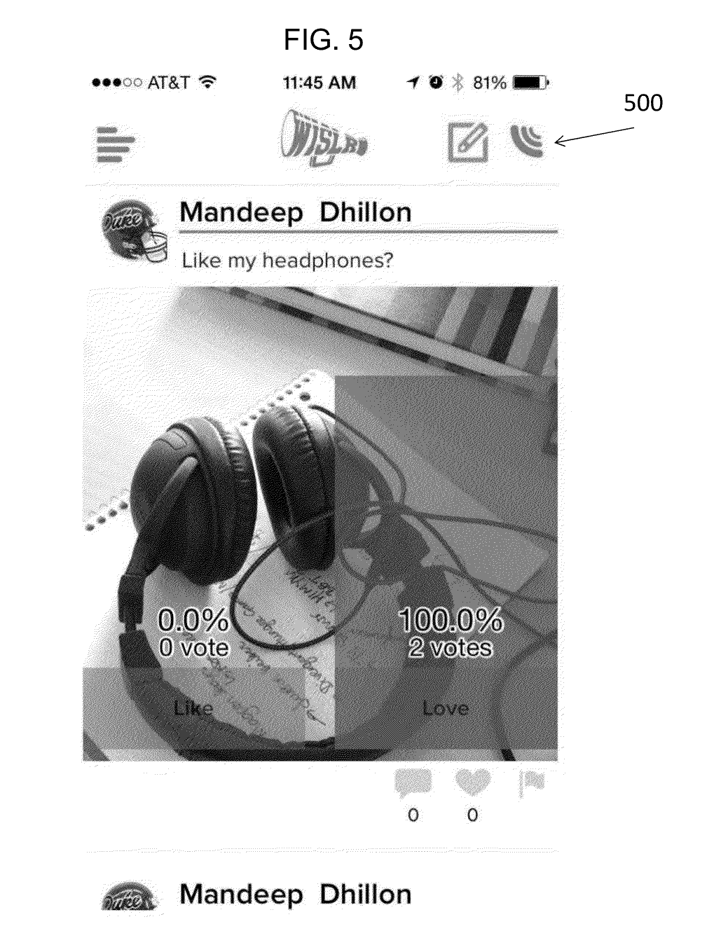

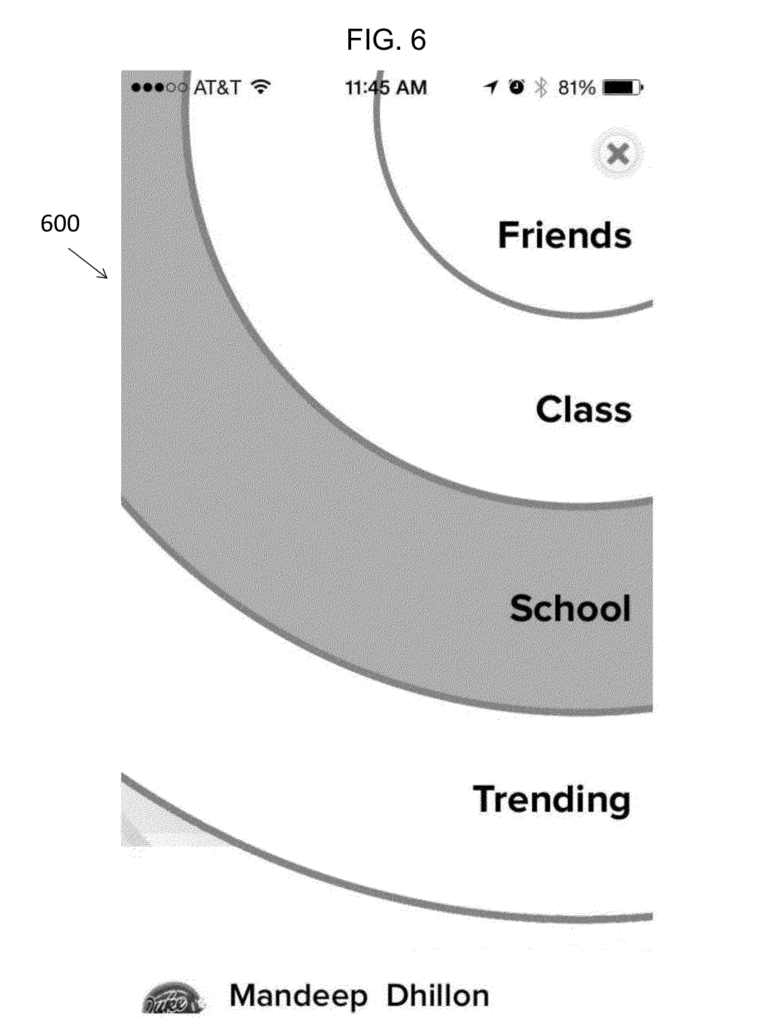

FIG. 5 is a display illustrating filtering consistent with certain aspects related to the innovations herein. A user first taps on the filter 500 as shown in FIG. 5 and it expands in the options 600 of FIG. 6. The method to expand the filter is called “openAnimation”.

FIG. 6 is a display illustrating feed selection consistent with certain aspects related to the innovations herein. In FIG. 6, a user selects their choice of filter “circles” to sort their feed by. The “touchEnded” method tells the app to sort by the specific feed. The User is then taken to the feed that is filtered by the selected filter.

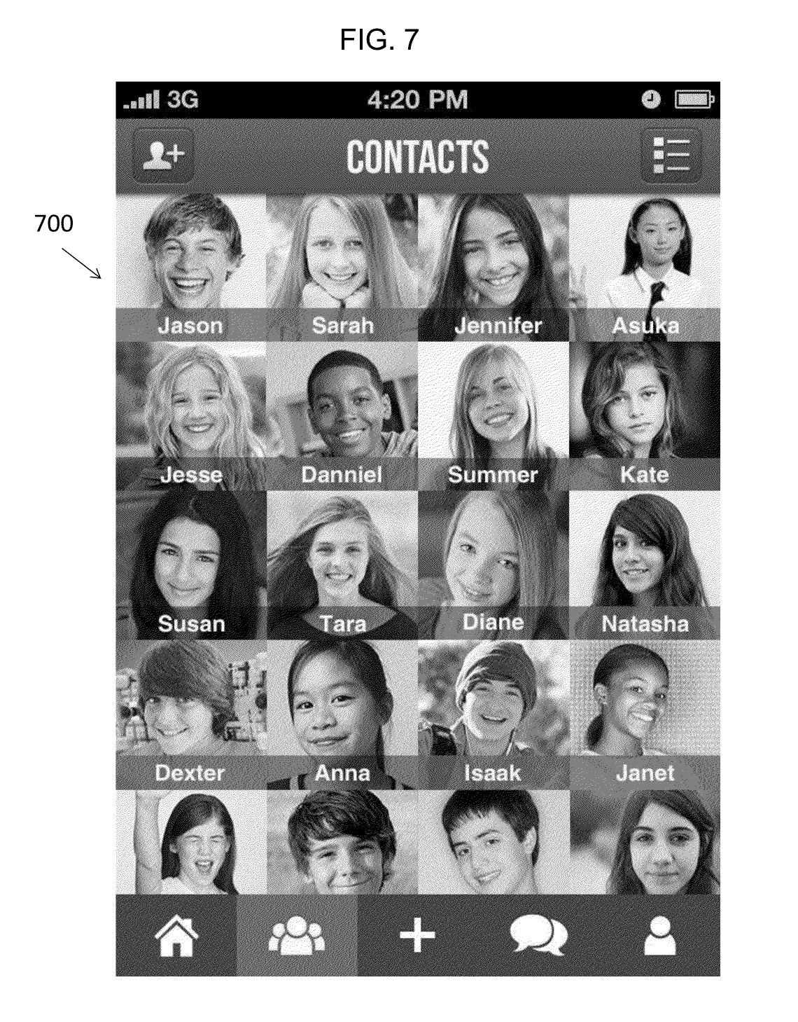

FIG. 7 is a display illustrating contacts consistent with certain aspects related to the innovations herein. Implementations herein allow visual switching between friend and classmate networks for users to easily toggle between friends and classmates. Users can easily and highly visually see their friends on the platform. A list of contacts 700 are displayed in FIG. 7.

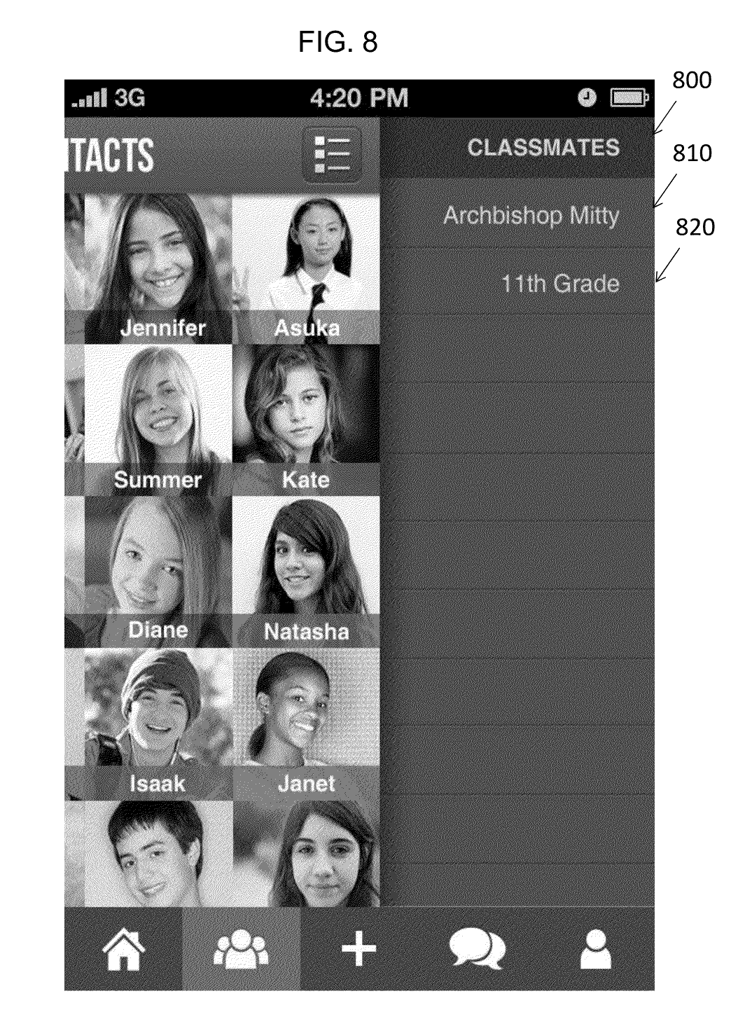

FIG. 8 is a display illustrating a contact filtering consistent with certain aspects related to the innovations herein. Here, for example, by one simple swipe left, the user may see a list of their current filter 800, school 810 and their grade 820.

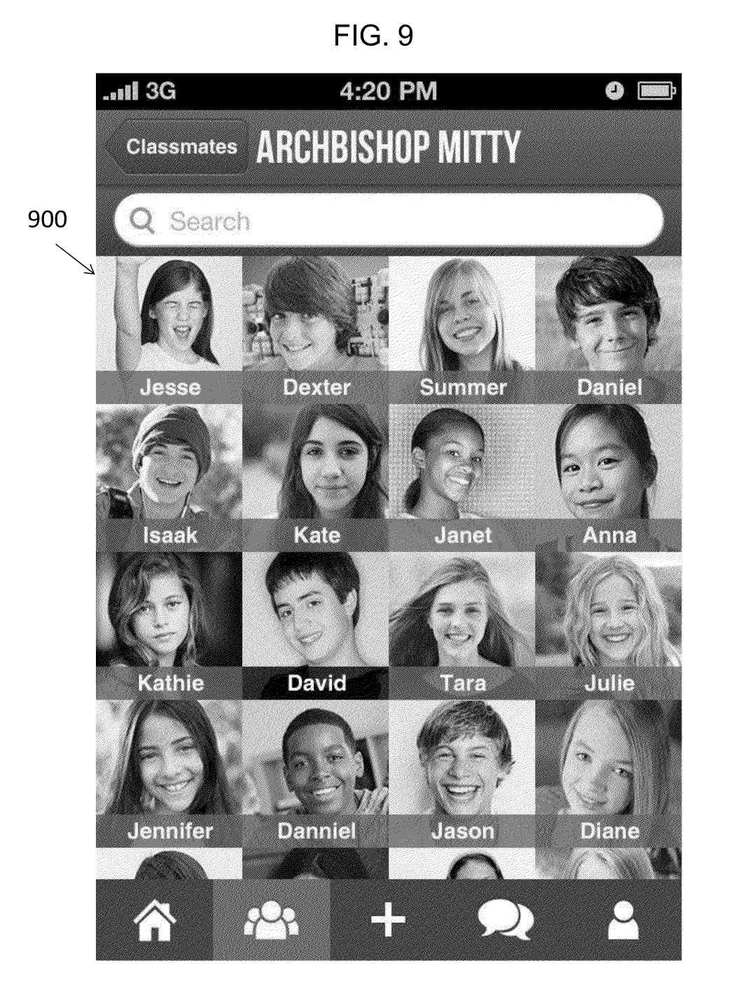

FIG. 9 is a display illustrating filtered contacts consistent with certain aspects related to the innovations herein. Upon selecting either option 810, 820 in FIG. 8, the user then sees their classmates in a similarly highly visual view in FIG. 9 as their friend list 900 where they can choose to engage. Users can easily go back to their friend list with one button tap.

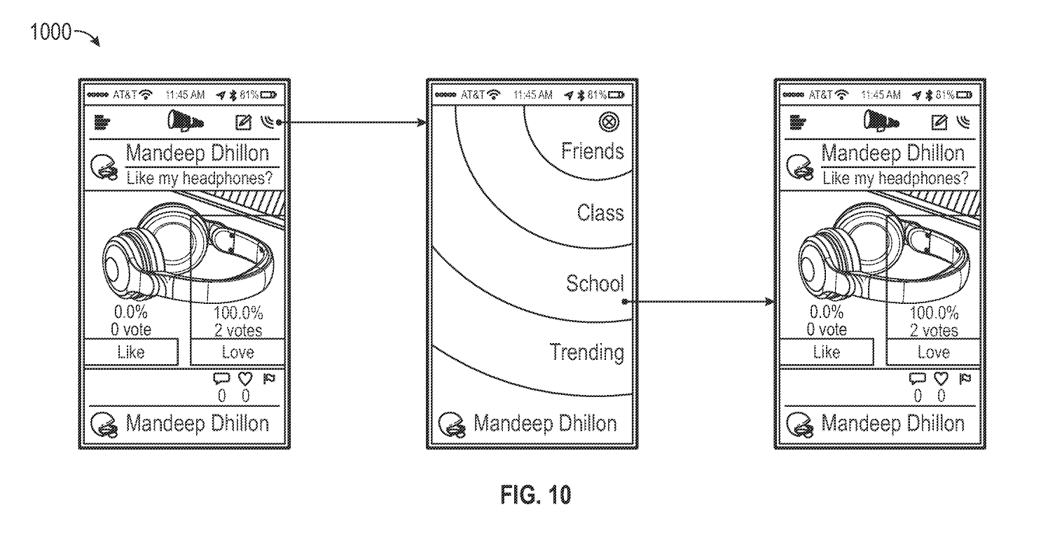

FIG. 10 is a display illustrating a filtering process consistent with certain aspects related to the innovations herein. As also set forth with respect to FIGS. 5 and 6, a user may tap on the filter in the top right and it expands to filter circles. The method to expand the filter is called “openAnimation.” The user then selects the filter that they'd like to sort their feed by. The “touchEnded” method tells the app to sort by the specific feed. The user is then taken to the feed that is filtered by the choice of the filter.

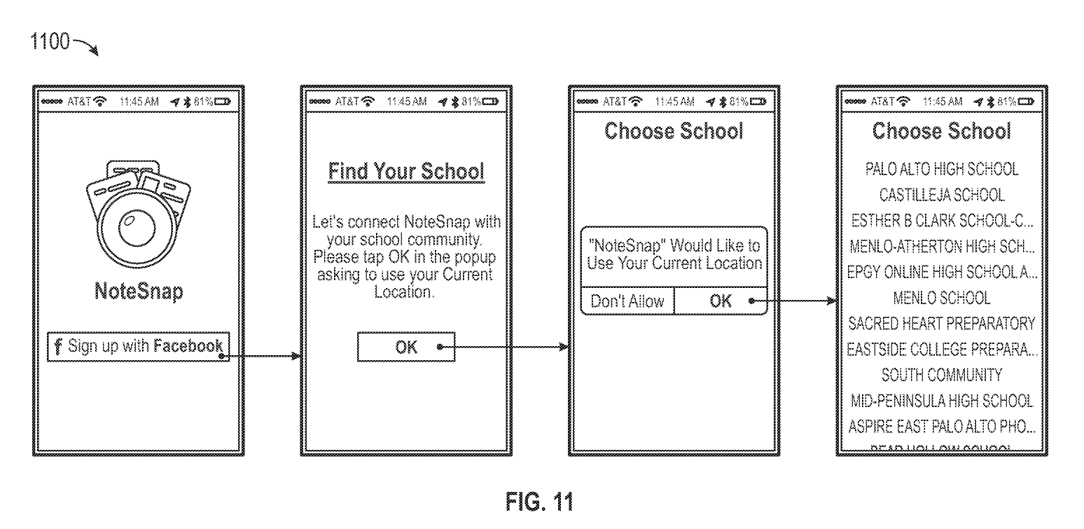

FIG. 11 is a display illustrating a selection process 1100 consistent with certain aspects related to the innovations herein.

1. When the user taps on the Facebook button, a user grants Facebook access to their data (name, friends list, dob, email, detailed friend data)

2. The application request the user's data from Facebook and adds it to the variable “joined User”

3. The verification process is then run which determines if the user is verified to pass into the app. The “signUpUser” method is when the verification occurs.

Is the user within the desired age range?

Does the user have the minimum number of Facebook friends required to access the app?

Does the user have a minimum number of Facebook friends that also go to their high school?

Does the user's FB schoolmates have an average age within an acceptable range.

4. If the user meets all of the requirements they can proceed to the next step.

The user taps on the OK button, as illustrated in the display 100 of FIG. 1, and this allows the application to request location permission, as illustrated in the display 200 of FIG. 2. The user agrees to give us permission to access their location.

At this point, the application calls the “loadSchools” method that uses the user's coordinates to retrieve nearby schools within a specified radius. The user can only signup for schools that are close by to them. FIG. 3 is a display 300 illustrating school selection with a plurality of schools within the specified radius. An alternative display 400 is provided in FIG. 4.

In other implementations, a student based high school social network is provided that uniquely identifies and validates student information on two different levels. During a sign up process to the high school network, the GPS coordinates of a user device will be determined by the user mobile device. A list of high schools within a predetermined radius of the user coordinates will be displayed, as illustrated in FIG. 4. Consequently, the GPS coordinates of a school are incorporated into a checking feature of a mobile device enabling the device to suggest schools closest to the student.

A first level of verification may require the user to checkin to their school using their phone's GPS. This initial layer of verification ensures the user is physically near their high school, limiting platform abuse and validating the authenticity of the established network. The second level of verification is social validation amongst classmates. For example, a polling feature may be implemented, where students will be asked polls if a certain user goes to their school or not. This methodology ensures that in case a user bypasses the first level of verification, the second can use crowdsourced identification to ensure users belong to a specific school. Other examples of social verification include social network contact matching such as Facebook friend matching to determine if the user is from a school.

In other implementations, a mobile social network is provided for high school that is a mobile only platform that creates a user experience tied around the high school experience. The application creates a social network combining messaging and social polling features, engaging users with their friends and classmates. Using GPS checkin, a feature specifically validated by mobile devices, users belong to their high school network and get access to their classmates for messaging and polling purposes.

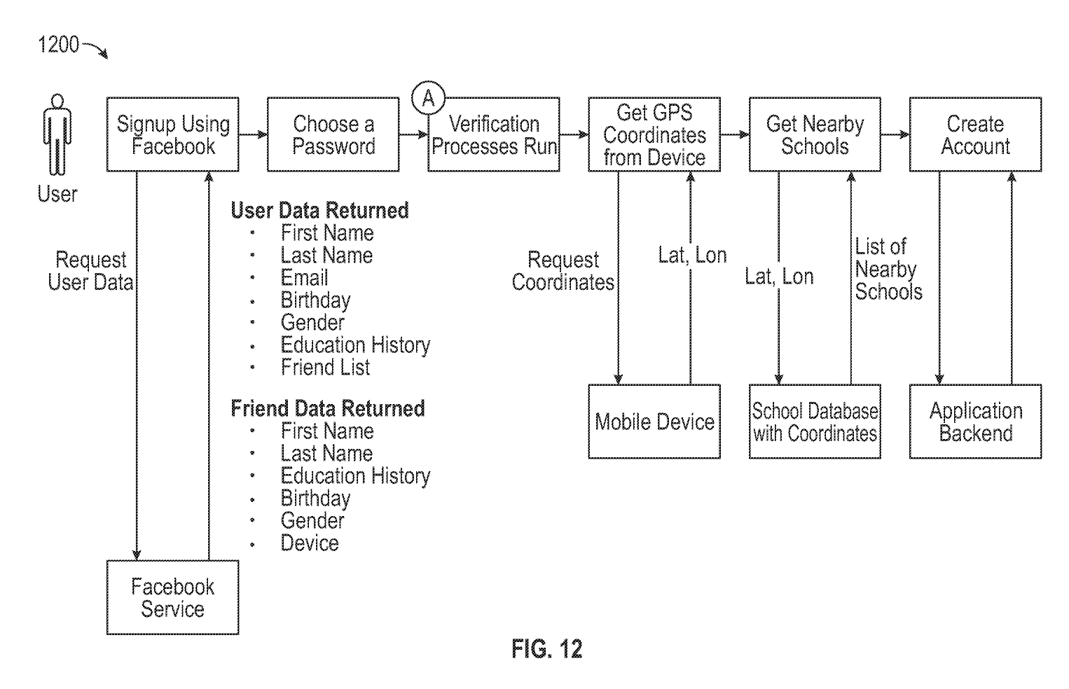

FIG. 12 is a display illustrating a setup process that may be integrated with other social networking data such as from Facebook.

In other implementations, the invention allows visual and tactile content filtering for users to filter their social stream to view polls by everyone, their school, friends, or their own. Using an innovative design, users can use tactile “hold and drag” to filter their stream down to specific content filters.

FIG. 10 is a display illustrating a filtering process consistent with certain aspects related to the innovations herein. A user first taps on the filter 500 as shown in FIG. 5 and it expands in the options 600 of FIG. 6. The method to expand the filter is called “openAnimation”. In FIG. 6, a user selects their choice of filter “circles” to sort their feed by. The “touch Ended” method tells the app to sort by the specific feed. The User is then taken to the feed that is filtered by the selected filter.

In other implementations, the invention allows visual switching between friend and classmate networks for users to easily toggle between friends and classmates. Users can easily and highly visually see their friends on the platform. A list of contacts 700 are displayed in FIG. 7. By one simple swipe left, the user sees a list of their current filter 800, school 810 and their grade 820. Upon selecting either option 810, 820, the user then sees their classmates in a similarly highly visual view in FIG. 9 as their friend list 900 where they can choose to engage. Users can easily go back to their friend list with one button tap.

In other implementations, the invention includes social polling—an innovative segment specific polling feature. Conventional polling apps and features are utilities—questions are asked and answers are crowdsourced validated. The value of these applications comes from the aggregate answers, not the users. The invention creates social polls—where the users are part of specific local networks (high schools) where teens can engage in polling with their classmates. The feedback and commenting not only provide a utility but have a social context because the users are people they know. Some innovative areas on social polling include:

1. Student Social Polling

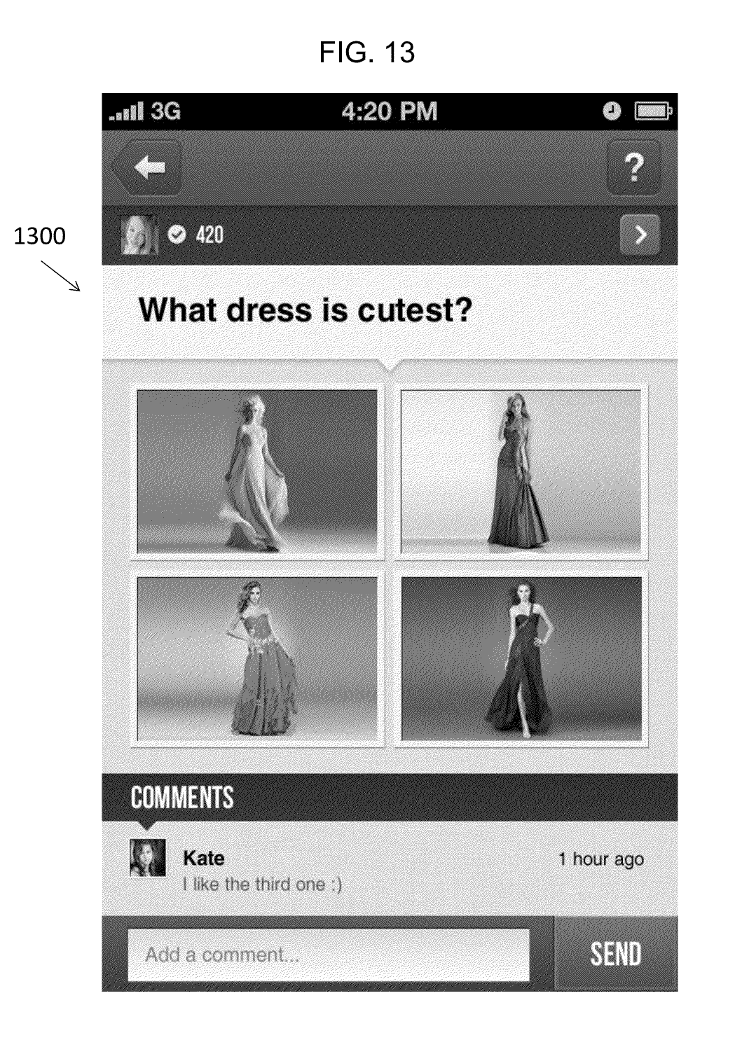

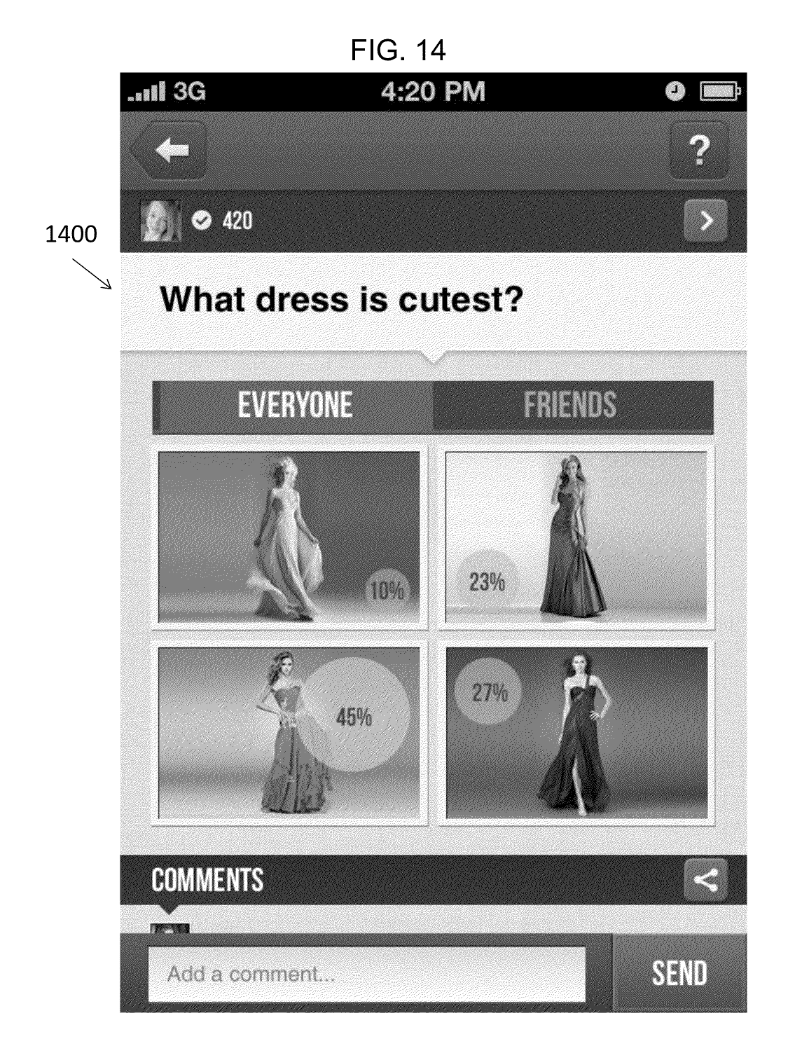

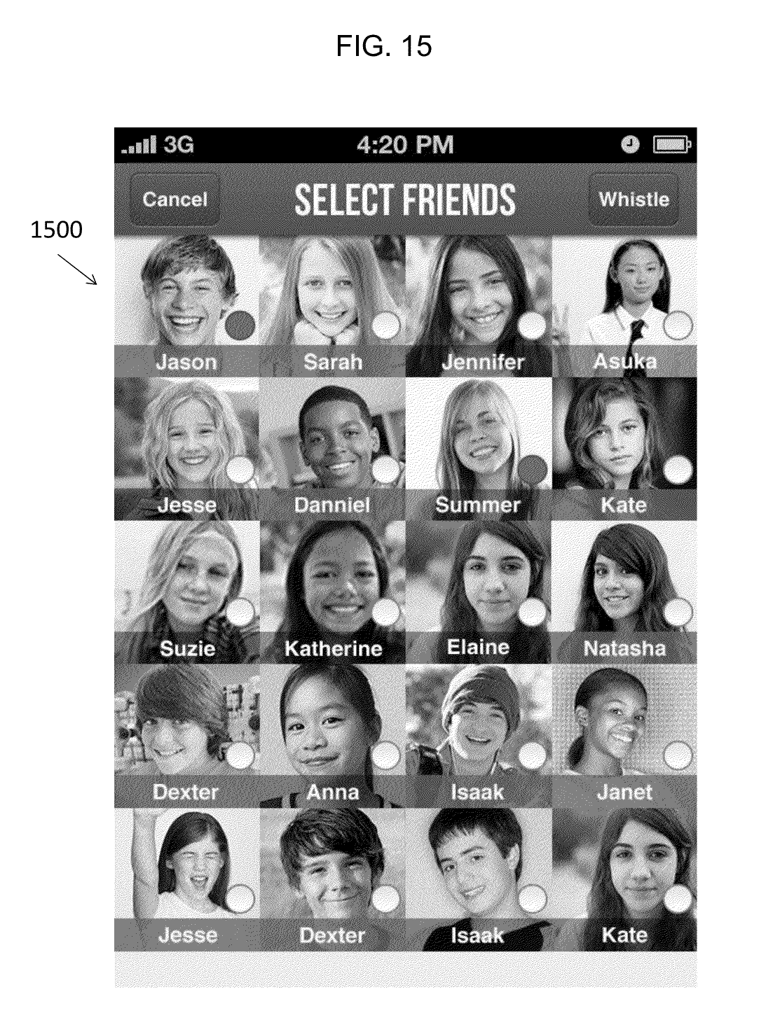

Unlike other polling applications that are utilities, the inventive social polling focuses on a specific segment of users making the results a social poll. Polls are asked and answered by other high school members and the results can be filtered by a user's own school or by their friends from their contact list, ensuring that not only do polls get answered but the polls get answered by relevant users. FIGS. 13 and 14 are displays 1300 and 1400 illustrating polling consistent with certain aspects related to the innovations herein. FIG. 15 is a display illustrating contact selection of friends 1500 for polling or other applications.

2. Send Poll with a Time Constraint

In other implementations, the invention allows users to create social polls sent to their friends or classmates that have a limited duration. The user asking the poll can set a time limit after which the poll expires. Users can engage with the poll, share it, and comment on it until the time limit ends at which point the poll is no longer accessible.

3. Poll Remix

In other implementations, the invention allows users to quickly remix already created polls for their own purposes. Users can edit the questions or photos of an existing poll and repurpose the poll as their own and can send it to their friends or school network. This feature promotes viral growth of interesting and popular poll questions or visuals that helps surface trending content on a local level.

4. Send Anonymous Poll to Defined Network

In other implementations, the invention allows users to send social polls to a specified high school network to create engaging platform content without any personal embarrassment. Users have a limited number of anonymous polls they can ask to the network or to individual users on the platform, where the asked users don't know who asked the question but the asker of course knows.

Messaging

In other implementations, the invention has a fully featured messaging platform for teens to communicate with their friends and classmates. Features include top end features such as sharing Google Images, Youtube videos, and other features. Some further innovative ideas include:

1. Inserting a Whistle into a Messaging Service

In other implementations, the invention provides the first mobile network that combines social polling features with messaging in a unique manner. Users can insert whistles into messaging two ways. The first way is through the social stream, where users can share the whistle through a button to select friends. The second way is during whistle creation, where a user can select friends to share it with directly. In both cases the whistles are sent through individual chats in messaging where users can answer the polls and comment on them.

Custom Image Visual

1. Custom Image Visuals

In other implementations, the invention allows users to create custom image visuals from any photo source—uploaded, taken, or from Image Search. Users can take photos, crop them, add shapes, colors, and stickers to these photos and save their own custom designed stickers. These stickers can be used throughout the messaging interactions as well as the polling interactions as comment substitutes.

Implementations and Other Nuances

The innovations herein may be implemented via one or more components, systems, servers, appliances, other subcomponents, or distributed between such elements. When implemented as a system, such system may comprise, inter alia, components such as software modules, general-purpose CPU, RAM, etc. found in general-purpose computers, and/or FPGAs and/or ASICs found in more specialized computing devices. In implementations where the innovations reside on a server, such a server may include or involve components such as CPU, RAM, etc., such as those found in general-purpose computers.

Additionally, the innovations herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the innovations herein may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

Innovative software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules or other data embodying the functionality herein. Further, communication media may include wired media such as a wired network or direct-wired connection, and wireless media such as acoustic, RF, infrared and other wireless media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission. Also, the modules can be implemented as hardware logic circuitry implementing the functions encompassed by the innovations herein. Finally, the modules can be implemented using special purpose instructions (SIMD instructions), field programmable logic arrays or mixtures of those or other suitable elements which provide the desired level performance and cost.

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though computer readable media herein does not encompass/include transitory media.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the present inventions have been specifically described herein, it will be apparent to those skilled in the art to which the inventions pertain that variations and modifications of the various implementations shown and described herein may be made without departing from the spirit and scope of the inventions. Accordingly, it is intended that the inventions be limited only to the extent required by the applicable rules of law.

1. A method of network processing, the method comprising:
determining an academic network of a user based on a mobile device location;
checking in to the academic network by the user; and
verifying the user by the academic network.

2. The method of claim 1, further comprising:
determining a plurality of schools based on the mobile device location.

3. The method of claim 1, wherein the user is verified based on the mobile device location.

4. The method of claim 1, wherein the user is socially verified.

5. The method of claim 4, wherein the user is socially verified based on a poll of academic network users.

6. The method of claim 4, wherein the user is socially verified via social network connection data.

7. The method of claim 6, wherein the social network connection data comprises Facebook friends.

8. A method of processing data, the method comprising:
displaying a plurality of social network contacts;
displaying a plurality of contexts of the social network contacts; and
switching display of social network contacts based on a selected context.

9. The method of claim 8, wherein the contexts include a social network and/or device contacts, a location and an academic context.

10. The method of claim 8, wherein selection is performed via touch gesture.
